(19) United States
(12) Patent Application Publication
(10) Pub. No.: US 2014/0345575 A1
(43) Pub. Date: Nov. 27, 2014

(54) CANISTER PURGING FOR PLUG-IN HYDRID ELECTRIC VEHICLES

(71) Applicant: FORD GLOBAL TECHNOLOGIES, LLC, DEARBORN, MI (US)

(72) Inventors: MARK W. PETERS, WOLVERINE LAKE, MI (US); ROBERT ROY JENTZ, WESTLAND, MI (US); DENNIS SEUNG-MAN YANG, CANTON, MI (US); AED M. DUDAR, CANTON, MI (US)

(73) Assignee: FORD GLOBAL TECHNOLOGIES, LLC, DEARBORN, MI (US)

(21) Appl. No.: 13/900,214

(22) Filed: May 22, 2013

(51) Int. Cl. F02M 25/08

(52) U.S. Cl. CPC F02M 25/08
USPC 123/520

(57) ABSTRACT

A method for desorbing fuel vapors from a canister of a vehicle having an internal combustion engine and a fuel tank includes detecting the temperature within the interior of the fuel tank using a temperature sensor positioned within the fuel tank. The canister is in fluid communication with the fuel tank and an intake manifold of the engine of the vehicle. A vapor bypass valve is positioned along a flow line between the fuel tank and the canister. The vapor bypass valve is opened if the temperature inside the fuel tank falls below a pre-determined value. The low pressure region created within the fuel tank due to fall in temperature is utilized to route ambient air along with the fuel-vapors contained within the canister, towards the fuel tank, through the opened vapor bypass valve.

### TECHNICAL FIELD

Embodiments of the present disclosure generally relate to emission control systems in automotive vehicles, and, more specifically, to systems and methods for desorbing hydrocarbon vapors from carbon canisters of emission control systems of automotive vehicles.

### BACKGROUND

Canisters containing adsorbent carbon are used in automotive vehicles to decrease pollution from vehicles, while maintaining vehicle fuel efficiency. Fuel present within the fuel tank of a vehicle can gradually evaporate. Fuel vapors from the fuel tank may escape to the atmosphere, causing air pollution. Even when the vehicle engine is turned off, these fuel vapors are produced. A carbon canister traps the fuel vapors and feeds them back to the engine of the vehicle for combustion

A carbon canister generally has a box-shaped structure, and commonly it is located near the fuel tank. The canister input is connected to a vent port of the fuel tank, and the output is connected to the intake manifold through a canister purge valve. When the engine is turned off, fuel is siphoned from the tank, creating low pressure within the tank. That decrease in turn increases the rate of fuel evaporation, generating fuel vapors. When the fuel tank's pressure equalizes, vapor flows from the tank to the carbon canister, where it is adsorbed by the carbon. When the vehicle's engine is restarted, suction from the intake manifold opens the canister purge valve, pulling the accumulated vapors into the intake manifold for combustion.

The canister purge valve, in addition to routing the fuel vapors from the canister to the intake manifold of the engine, also controls the flow of fuel vapor routed to the engine for combustion this valve may be a solenoid valve, or similar component, controlled by the power train control module of the vehicle.

The process of “purging” accumulated vapor from the canister depends upon having the engine running to generate suction in the intake manifold. In case of plug-in Hybrid Electric Vehicles (PHEVs), however, engine running time is limited, which of course limits the possibilities for purging. Meeting emission norms and regulations in many jurisdictions depends upon a certain amount of purging, which poses a problem for PHEV's. Indeed, the engine may need to be operated solely for the purpose of purging the canister. Such extra use of the engine may lead to decreased fuel economy. On the other hand, failing to purge the may release hydrocarbons and other fuel components into the atmosphere.

Considering the problems mentioned above, there exists a need for a more effective and efficient system and method for purging fuel vapors from the carbon canister, without compromising the fuel economy efficiency of the vehicle.

### SUMMARY

In one aspect of the present disclosure, an evaporative emission control system for a vehicle having a fuel tank and an internal combustion engine includes a canister in fluid communication with both the fuel tank and an engine intake manifold. The canister contains absorbent material for absorbing hydrocarbons carried in fuel vapor and the fluid communication is accomplished by flow lines. The canister purge valve is positioned in the flow line between the canister in the intake manifold, and he vapor bypass valve is positioned in the flow line between the canister and fuel tank. Within the fuel tank, a temperature sensor is positioned to measure and transmit the temperature within the fuel tank. The system is controlled by a programmable control module, coupled to the temperature sensor, the canister purge valve, and the vapor bypass valve. The programmable control module configured for receiving a signal from the temperature sensor; determining whether the temperature inside the fuel tank is below a predetermined value; and, upon a determination that the temperature is below the predetermined value, generating a signal for opening the vapor bypass valve.

Additional aspects, advantages, features and objects of the present disclosure will be made apparent from the drawings and the detailed description of the illustrative embodiments construed in conjunction with the appended claims that follow.

### BRIEF DESCRIPTION OF THE DRAWINGS

FIG. 1 is a schematic diagram of an evaporative emission control system for purging a carbon canister of a vehicle, according to an embodiment of the present disclosure.

FIG. 2 is a temperature curve illustrating the variation in the temperature within the fuel tank of a vehicle over a 24 hour period.

FIG. 3 is a flowchart setting out a method for purging a carbon canister, according to an embodiment of the present disclosure.

### DETAILED DESCRIPTION OF ILLUSTRATIVE EMBODIMENTS

Definitions: The following definitions are used in this disclosure.

Artificial vacuum: A vacuum created by a vacuum pump or other mechanical device.

Communication or fluid communication: A mechanism by which gas or liquid or both can travel from one point to another. Commonly, this might be effected by tubing or piping.

Natural vacuum: A vacuum created by the contraction of gas, liquid or both as a result of decrease in ambient temperature. No mechanical vacuum pump or other mechanical method is used to generate a natural vacuum. However, mechanical valves can be used to control a natural vacuum.

The following detailed description illustrates aspects of the disclosure and its implementation. This description should not be understood as defining or limiting the scope of the present disclosure, however, such definition or limitation being solely contained in the claims appended thereto. Although the best mode of carrying out the invention has been disclosed, those in the art will recognize that other embodiments for carrying out or practicing the invention are also possible.

Carbon canisters collect vapor emerging from the fuel tank to prevent vapor from escaping into the environment. The canister is generally filled with charcoal or activated carbon, to adsorb fuel vapor. The canister receives vapor inputs from the fuel tank, retains those vapors for a time, and then outputs them to the engine intake manifold. Flow lines extend from the fuel tank to the canister input port, and from the canister output port to the intake manifold. A canister purge valve lies in the line between the intake manifold and the canister, and a vapor bypass valve lies in the flow line between the canister and the fuel tank. A third line connects the canister to ambient atmosphere, through a canister valve solenoid. The activated carbon within the canister captures fuel vapor emerging from the fuel tank. When the engine starts, suction within the engine intake manifold opens the canister purge valve and polls fuel vapor accumulated within the canister into the intake manifold, where it is burned. As is well known, plug-in hybrid electric vehicles (PHEV's) minimize engine running time, which has the effect of minimizing canister purging Running the engine solely to purge the canister may waste substantial fuel. On the other hand, accumulation of fuel vapor in the canister beyond a certain level presents an environmental hazard. Diurnal temperature variation may increase pressure within the fuel tank as the day heats up, forcing fuel vapors into the canister. If the canister becomes overloaded, fuel vapor may vent to the atmosphere.

Environmental regulations are steadily tightening the standards for vehicle vapor emissions. Environmental authorities in certain regions, such as California, typically require less than about 500 mg of hydrocarbons released as vehicle evaporative emissions in a standard 3 day test. Given other sources of emissions, the standard effectively limits canister emissions to less than about 200 mg. Euro 5/6 regulations enforce a limit of about 2 grams of evaporative emissions per day. Such stringent conditions demand a highly efficient and effective evaporative emission control system, which in turn requires regular canister purging.

The present disclosure provides a more efficient and fuel-economic emission control system as well as a method for controlling fuel-vapor emissions in a plug-in hybrid electric vehicle. Accumulated vapors within the vehicle's carbon canister can be easily desorbed without the need for the engine of the vehicle to be turned on. The disclosed emission control system utilizes the low pressure region created naturally within the fuel tank of a vehicle at certain times of the day to desorb fuel vapors from the canister and route the vapors back to the fuel tank.

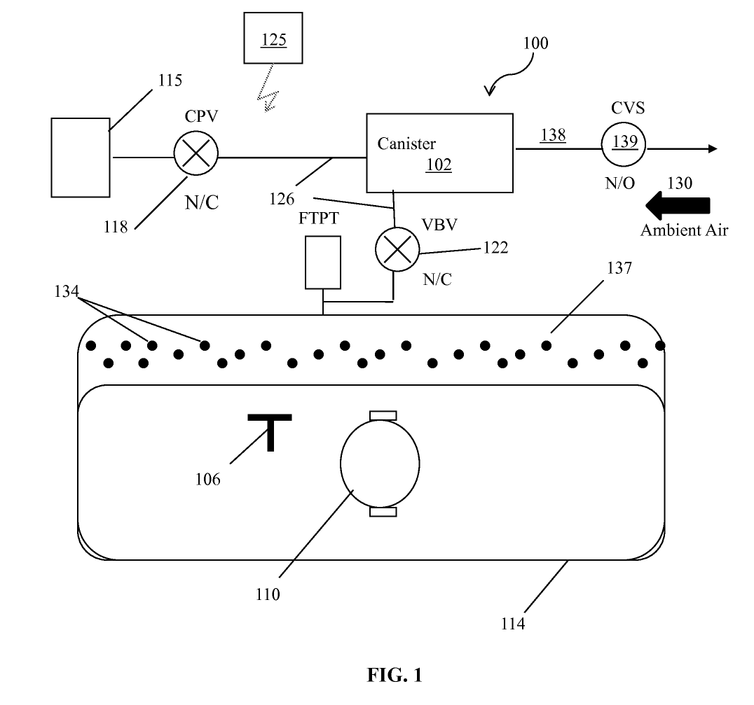

FIG. 1 is a schematic view of an evaporative emission control system 100 for a vehicle, configured to facilitate purging fuel vapors from a carbon canister. As shown, the system includes a carbon canister 102 linked by vapor flow lines 126 with a fuel tank 114 and the vehicle's intake manifold 115. O. A normally closed vapor bypass valve (VBV) 122 lies in the line between the canister 102 and the fuel tank 114 and canister purge valve 118, also normally closed, lies in the line between the canister 102 and intake manifold 115. A fresh air line 138, controlled by normally open canister valve solenoid (CVS) 137, opens to the atmosphere. A programmable control module 125 is coupled to CPV 118, VBV 122, and CVS 1372 effect their operation. A fuel pump 110 impels fuel from the tank 114 to intake manifold 115 through a fuel line, not shown.

A temperature sensor 106 is also positioned within fuel tank 114, to measure the temperature there. Though only one temperature sensor 106 is shown, multiple such sensors may be disposed within the fuel tank 114. An average of the temperature values detected by those sensors can be taken in some embodiments, to obtain a more precise measure of the temperature within the interior of the fuel tank 114.

Evaporative emission control system 100 operates as follows. As noted above, CPV 118 and VBV 122 are normally closed. Thus, canister 102 is generally sealed off from both of the fuel tank 114 and the intake manifold 115. As the engine starts, CPV 118 opens, and the suction created within intake manifold draws air through normally open CVS 139, through fresh air line 138 and canister 102, and then on through flow line 126 and CPV 118, and into intake manifold 115. As the fresh air passes through canister 102, hydrocarbons accumulated in the activated carbon are desorbed and entrained by the airflow. These hydrocarbons accompany the air into the intake manifold 115, and into the engine (not shown), where they are burned. This purging action can only occur, of course, when the engine is running.

As known by those in the art, an overall goal of evaporative emission control system 100 is to compensate for the expansion and contraction of fuel vapors, without allowing any of those vapors to escape to the atmosphere. The valves disclosed here allow the fuel system to be considered as a sealed system, and thus the behavior of the fuel vapor can be modeled by the ideal gas equation, PV=nRT. In general terms, as the temperature within fuel tank 114 rises, either due to an increase in ambient temperature or operation of the vehicle itself, fuel vapor 134 will tend to expand, while an opposite change in temperature leads to contraction.

The temperature within fuel tank 114 is continuously monitored by PCM 125, which receives temperature signals from the temperature sensor 106. By determining the volume of vapor space 137 (derived from the known fuel level) knowing the temperature allows calculation of pressure levels. Here, reduced temperature within fuel tank 114 indicates a low pressure within vapor space 137. When pressure is sufficiently low that suction is created within vapor space 137, VBV 122 is opened, this time allowing fresh air to flow through CVS 139, through canister 102, and into fuel tank 114. There, fuel vapor 134 is subjected to sufficiently low pressure that it condenses back into liquid form. In this manner, canister 102 is purged of accumulated hydrocarbons.

Effectively, the present disclosure eliminates the need to rely on the engine to purge canister 102. The evaporative emission control system 100 automatically purges fuel-vapors from the canister 102 by routing them towards the fuel tank 114 regularly, whenever the temperature within the fuel tank 114 falls.

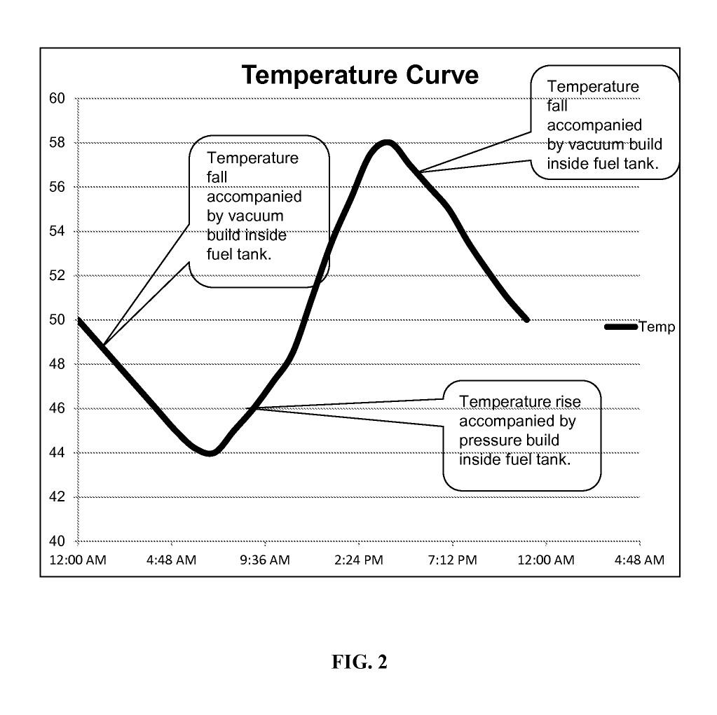

FIG. 2 is a chart illustrating the diurnal range of temperature variation inside the vehicle fuel tank. As would be expected, temperature begins rising around dawn and keeps rising until around sunset. From that high point, temperature falls steadily until the sun reappears. It will be understood that the temperature curve of FIG. 2 assumes that the automotive vehicle spends most of its time outdoors. No matter where the car is housed, however, its ambient temperature will follow some sort of diurnal cycle up and down

In this illustration, from midnight till early morning hours. The temperature may eventually fall from 50° F. to about 44° F. on a summer day. However, the range of variation may be substantially different from the illustrated temperature curve, based on the climatic conditions of a specific region. From morning hours, till the afternoon, the temperature in this illustration may eventually rise to about 58° F., and thereafter, starts falling again.

A drop in temperature is accompanied by a vacuum buildup within the fuel tank, while a rise in temperature has the opposite effect, increasing pressure within the tank. In an embodiment, the pre-determined temperature of the fuel tank, below which enough suction pressure is created within the fuel tank for drawing vapors from the canister, may be varied between about 45° F.-50° F. When the temperature sensor in the fuel tank detects that the fuel tank's temperature is below the chosen pre-determined temperature, the programmable control module opens the vapor bypass valve. Otherwise, vapor bypass is kept closed.

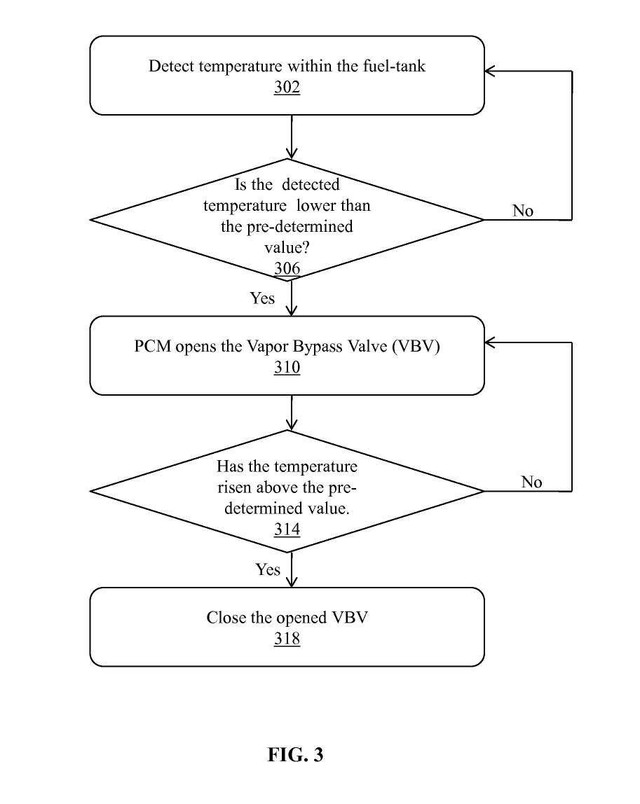

FIG. 3 illustrates the steps involved in an exemplary method according to the present disclosure, for purging the carbon canister of a plug-in hybrid electric vehicle, using low pressure region created within the vehicle fuel tank. At step 302, the method involves detecting temperature within the vehicle fuel tank. At step 306, the method involves checking whether the detected temperature is below a threshold predetermined temperature value. If “yes”, then at step 310, the PCM opens the vapor bypass on the flow line between the canister and the fuel tank. This allows ambient air along with fuel-vapors accumulated in the canister to be sucked into the fuel tank. If “no” at step 310, the method loops back to step 302 and detection of the temperature of the fuel tank continues.

At step 314, once the vapor bypass has been opened, the method has continuously checking of whether temperature within the fuel tank has risen again above the pre-determined value. If “yes”, then at step 318, the programmable control module closes the vapor bypass. However, if “no”, then the VBV is kept open.

The method and the system of the present disclosure can be used for any vehicle, preferably for a hybrid vehicle, most preferably for a plug-in hybrid electric vehicle, including a car, an SUV, a truck, etc. The method is much more efficient and does not waste fuel and energy by requiring the vehicle's engine to be turned on for purging hydrocarbon vapors from the carbon canister of a vehicle.

Although the current invention has been described comprehensively, in considerable detail to cover many possible aspects and embodiments, those skilled in the art would recognize that other versions of the invention are also possible.

What is claimed is:

1. An evaporative emission control system for a vehicle having a fuel tank and an internal combustion engine, the system comprising:
a canister containing absorbent material, in fluid communication via flow lines with both the fuel tank and an engine intake manifold;
a canister purge valve in a flow line between the canister and the intake manifold;
a vapor bypass valve positioned in a flow line between the canister and the fuel tank;
at least one temperature sensor positioned inside the fuel tank; and
a programmable control module coupled to the temperature sensor, the canister purge valve, and the vapor bypass valve, the programmable control module configured for
receiving a signal from the temperature sensor;
determining whether the temperature inside the fuel tank is below a predetermined value;
upon a determination that the temperature is below the predetermined value, generating a signal for opening the vapor bypass valve.

2. The evaporative emission control system of claim 1, wherein the vehicle incorporating the system is a plug-in hybrid electric vehicle.

3. The evaporative emission control system of claim 1, wherein the programmable control module is configured to close the vapor bypass valve in response to the temperature inside the fuel-tank rising above the pre-determined value, as detected by the temperature sensor.

4. The evaporative emission control system of claim 1, wherein the vehicle fuel tank is sealed

5. The evaporative emission control system of claim 1, further including a canister valve solenoid, normally open, positioned in a flow line between the canister and an event to fresh air.

6. A method for desorbing fuel vapors from a canister of a vehicle having an internal combustion engine and a fuel tank, the method comprising:
detecting temperature within the interior of the fuel tank using a temperature sensor positioned within the fuel-tank, the canister being in fluid communication with the fuel-tank and an intake manifold of the engine of the vehicle, wherein a vapor bypass valve is positioned in a flow line between the canister and the fuel tank;
opening the vapor bypass valve upon a determination that the temperature inside the fuel-tank falls below a pre-determined value; and
whereby, fuel vapor from the canister flows into the program fuel tank.

7. The method of claim 5, further comprising, closing the vapor isolation valve to isolate the fuel-tank from the canister if the temperature inside the fuel-tank rises above the pre-determined value.

8. The method of claim 5, being implemented on a plug-in hybrid electric vehicle.
